(19) United States
(12) Patent Application Publication
(10) Pub. No.: US 2013/0056592 A1
(43) Pub. Date: Mar. 7, 2013

(54) APPARATUS AND METHOD TO SUPPORT BUILDING MEMBERS DURING INSTALLATION

(71) Applicant: Jason Greenhalgh, Atascadero, CA (US)

(72) Inventor: Jason Greenhalgh, Atascadero, CA (US)

(21) Appl. No.: 13/223,317

(22) Filed: Sep. 1, 2011

(51) Int. Cl. F16L 3/08; F16M 13/02; E04B 1/35; F16M 13/00

(52) U.S. Cl. 248/70; 248/295.11; 248/231.91; 248/216.1; 248/222.14; 52/741.1

(57) ABSTRACT

A portable apparatus for temporarily supporting one end portion of a building element includes a primary support rail and a support member. The support member is adjustably and movably coupled to the primary support rail. The support member is configured to temporarily support an end portion of a building member and is coupled to the primary support rail via an adjustment mechanism. Actuation of the adjustment mechanism is effective to adjust a relative position of the support member along the primary support rail.

### FIELD OF THE INVENTION

The field of the invention relates to the installation of various elements in buildings or other structures and more specifically to approaches for aiding in the installation of these building elements.

### BACKGROUND OF THE INVENTION

Carpenters, home owners, and others often need to install various building elements or members onto or at different building support structures. For example, there is often the desire to attach a building member such as a crown molding, board, piece of siding, or pipe to a building support structure such as a wall, ceiling, rafter, or floor.

Many of these building members are long or otherwise difficult to attach to a building structure. For instance, pieces of crown molding are often long or otherwise difficult to handle or grip.

Moreover, the length of these elements makes it difficult for a single person to attach these to a building structure. For example, if a long piece of pipe or crown molding is to be attached to a wall, then at least two people (and sometimes more) are required to be available to complete the installation. A first person holds the crown molding on one end while a second person must hold the crown molding on the other end; one of these installers attaches the molding to the wall. Without the help of the second person, the crown molding will fall to the ground and the crown molding cannot be successfully applied to the wall.

Many homeowners are single, live alone, have difficulty finding, or do not want to hire/use a second person as a helper. Unfortunately, they have no option but to hire a second worker if they wish to install the building member.

Furthermore, there is a great deal of pressure for builders, building contractors, and others to reduce costs when installing various building members. The requirement of using at least two workers to install building members makes a project more expensive and reduces profits significantly.

Previous approaches have not addressed the above-mentioned problems resulting in dissatisfaction amongst home owners, contractors, builders, and others.

### SUMMARY OF THE INVENTION

An apparatus is provided that allows a single human installer to install building members (e.g., crown moldings, boards, pieces of siding, or pipes to mention a few examples) without the need for help from another human helper. The devices described herein are easy to assemble and allow the building member to be attached to a building structure (e.g., a wall, rafter, or ceiling, to mention a few examples) quickly and easily. Furthermore, the devices are portable and can be moved from job-to-job or from location-to-location quickly and with ease.

In many of these embodiments, a portable apparatus for temporarily supporting one end portion of a building element or member includes a primary support rail and a support member. The support member is adjustably and movably coupled to the primary support rail. The support member is configured to temporarily support an end portion of the building member and is coupled to the primary support rail via an adjustment mechanism. Actuation of the adjustment mechanism is effective to adjust a relative position of the support member along the primary support rail. It will be appreciated that the adjustment mechanism can be omitted and that the support member can be permanently coupled to the rail and be non-movable.

In some aspects, the support member is a pipe-supporting bracket, a crown molding supporting bracket, a siding support bracket, or a board-supporting bracket. In other aspects, the adjustment mechanism is a turnable knob. In still other examples, the building member is a pipe, a crown molding, a section of siding, or a board. Other examples of support members, adjustment mechanism, and building members are possible.

In still other examples, the primary support rail comprises a slot and the support member is configured to be coupled to the rail via a fastener that extends into the slot. In some aspects, the primary support rail includes a wall attachment member and the wall attachment member is configured to attach the primary support rail to a wall. In other aspects, the wall attachment member is a nail or a screw.

In others of these embodiments, a kit includes a portable apparatus that can be assembled to temporarily support one end portion of a building element, for example, when the building element is installed. In other potential uses, the support member can be used to support other elements such as scaffolding. More specifically, the kit includes a primary support rail and one or more support members. The support members are adjustably and movably coupled to the primary support rail. Each of the support members is configured to temporarily support an end portion of one of the building members. Each of the support members are configured to be coupled to the primary support rail via an adjustment mechanism. Actuation of the adjustment mechanism is effective to adjust a relative position of the particular support member along the rail.

In still others of these approaches, a single user attaches a building element to a building support structure without the need of a human helper. More specifically, the single user attaches a primary support rail to a building support structure. The primary support rail is coupled to a support member and the support member is configured to temporarily support an end portion of a building member. One end of the building member is supported by the support member while the user may support the other end. The building member is secured to the building support structure without help from another human helper.

In some aspects, the building support structure is a wall. In other aspects, the building member is a pipe, a crown molding, a section of siding, or a board. In still other aspects, the primary support rail includes a wall attachment member and the wall attachment member is configured to attach the primary support rail to a wall. In yet other aspects, the wall attachment member is a nail or a screw. Other examples of the above-mentioned elements are possible.

### BRIEF DESCRIPTION OF THE DRAWINGS

FIG. 1A is a perspective view of an apparatus to support building support members during installation according to various embodiments of the present invention;

FIG. 1B is a cross-sectional side view of the apparatus of FIG. 1A according to various embodiments of the present invention;

FIG. 1C is a perspective view of the apparatus of FIG. 1A and FIG. 1B that supports building support members during installation according to various embodiments of the present invention;

FIG. 2A is a side view of an apparatus to support building support members during installation according to various embodiments of the present invention;

FIG. 2B is a front view of the apparatus of FIG. 2A according to various embodiments of the present invention;

FIG. 3A is a side view of an apparatus to support building support members during installation according to various embodiments of the present invention;

FIG. 3B is a side view of the bracket used in the apparatus of FIG. 3A according to various embodiments of the present invention;

FIG. 4A is a side view of a bracket used to support small pipes according to various embodiments of the present invention;

FIG. 4B is a side view of a siding bracket according to various embodiments of the present invention;

FIG. 4C is a side view of a bracket used to support ledgers according to various embodiments of the present invention;

FIG. 4D is a side view of a bracket to support large pipes according to various embodiments of the present invention;

FIG. 4E is a side view of a bracket to support crown molding according to various embodiments of the present invention;

FIG. 5A is a side view of a rail according to various embodiments of the present invention;

FIG. 5B is a front view of the rail of FIG. 5A according to various embodiments of the present invention;

FIG. 5C is a front view of another rail according to various embodiments of the present invention;

FIG. 5D is a side view of the rail of FIG. 5C according to various embodiments of the present invention;

FIG. 6 is a flowchart of an approach for installing a building element according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

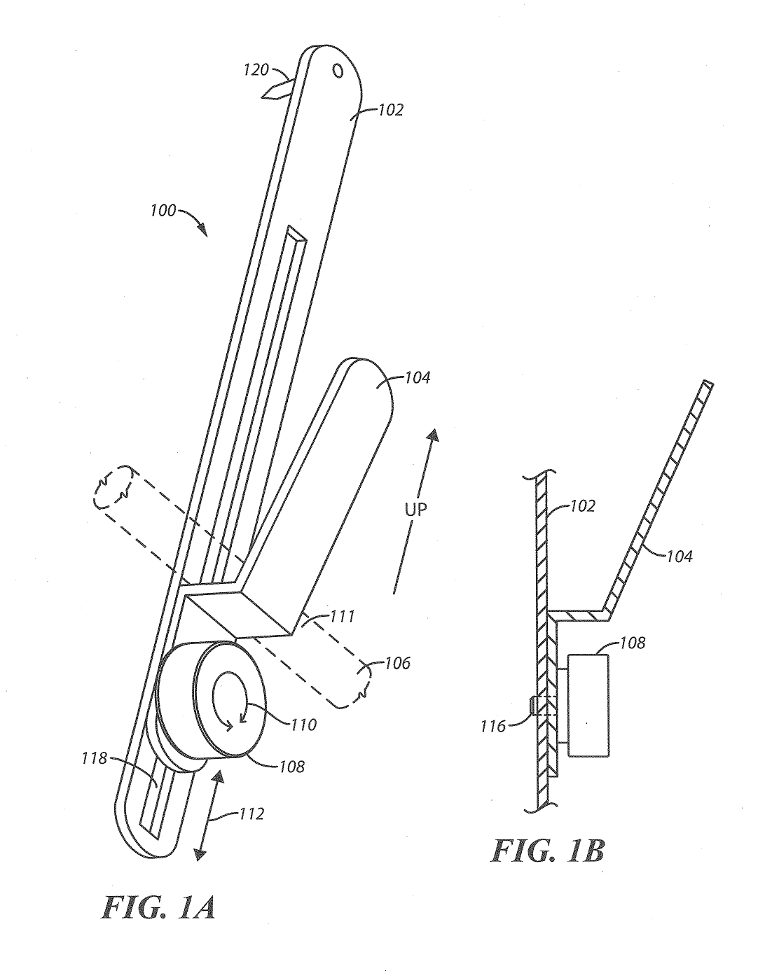

Referring now to FIG. 1A, FIG. 1B, and FIG. 1C, one example of an apparatus 100 that is used to support building support members during their installation is described. The apparatus 100 includes a primary support rail 102 and a support member 104. The support member 104 is adjustably and movably coupled to the primary support rail 102 (via a slot as described below). The support member 104 is configured to temporarily support an end portion 111 of a building member 106 (shown with dashed lines in FIG. 1A) and is coupled to the primary support rail 102 via an adjustment mechanism 108. The other end 115 of the building member may be supported by a human user 124. Actuation of the adjustment mechanism 108 is effective to adjust a relative position of the support member 104 along the primary support rail 102. In other examples, the adjustment mechanism 108 may be omitted and the member 104 secured to a permanent location along the rail 102.

The support member 104 can be configured to support a variety of different types, shapes, dimensions, and weights of building members. For example, the support member 104 may be a pipe-supporting bracket, a crown molding supporting bracket, a siding support bracket, or a board-supporting bracket. Other examples of support members are possible. The support member 104 may be constructed of any suitable material such as a metal, plastic, or wood. Other materials may also be used.

In other aspects, the adjustment mechanism 108 is a turnable knob (with an integral screw portion 116) that turns in the direction of the arrow labeled 110. Other adjustment mechanisms can also be used. In this particular example, turning the mechanism 108 in an appropriate direction moves the screw portion 116 through the member 104, and then through a slot 118 in the rail 102 to provide a secure connection between the rail 102 and the support member 104. This action allows a user to move the support member 104 up and down the rail 102 in the direction indicated by the arrow labeled 112.

In some aspects, the primary support rail 102 includes a wall attachment member 120 and the wall attachment member 102 is configured to attach the primary support rail 102 to a wall 122. The member 120 may be configured to attach the rail 102 to other building structures as well. In still other aspects, the wall attachment member 120 is configured as a nail or a screw thereby allowing the user to simply pound (or screw in) the rail 102 into a wall (or other building structure). The rail 102 may be constructed of any suitable material such as a metal. Other examples of materials are possible.

In one example of the application of these approaches, the single user 124 attaches the building element 106 to a building support structure 122 (e.g., a wall) without the need of a human helper. The single user 124 attaches the primary support rail 102 to the building support structure 122, for example by pounding the member 120 into the structure 122. One end 111 of the building member 106 is secured, supported, or held with or using the support member 104 while the other end is secured by the human user 124. It can be seen that the building member 106 can then be secured to the building support structure 122 by the user 124 without help from another human helper. In some aspects, the building support structure 122 is a wall, rafter, or ceiling, to mention a few examples. Other examples of building members are possible.

In other aspects, a kit may be provided that includes the portable apparatus 100. More specifically, the kit includes the primary support rail 102 and one or more support members (e.g., the member 104 or any of the other support members described herein). The human user 124 can select a particular support member from the kit and couple this member to the primary support rail 102. The selection may be based upon the type of building member to be installed, the dimensions of this member, and/or the weight member to mention a few considerations. When the building member is installed, the support member from the kit may be coupled to the rail. The apparatus 100 can be then attached to a building support structure so that installation of the building member can be completed. For instance, the wall attachment member 120 may be pounded into a wall to attach the apparatus 100 to the wall. Once installation is complete, the apparatus 100 can be detached from the structure 122 (e.g., by pulling it out of the wall). In other examples, the rail 102 may be first secured to the building member 122 and then the support member 104 coupled to the rail 102.

Each of the support members of the kit is configured to temporarily support an end portion of a different building member and the support members are coupled to the primary support rail via the adjustment mechanism 108. Actuation of the adjustment mechanism 108 by the human user (e.g., by turning the mechanism 108) is effective to adjust a relative position of the each of the support members along the primary support rail 102 when each of the support members is coupled to the primary rail 102. In so doing, adjustments can be made dynamically and as needed by the human user 124.

Thus, the single user 124 can install building members (e.g., crown moldings, boards, pieces of siding, or pipes) without the need for help from another human helper. The apparatus 100 is easy to assemble and allows the building member 106 to be attached to the building structure 122 quickly and easily. Further, the apparatus 100 is portable and can be moved from job-to-job or location-to-location with ease.

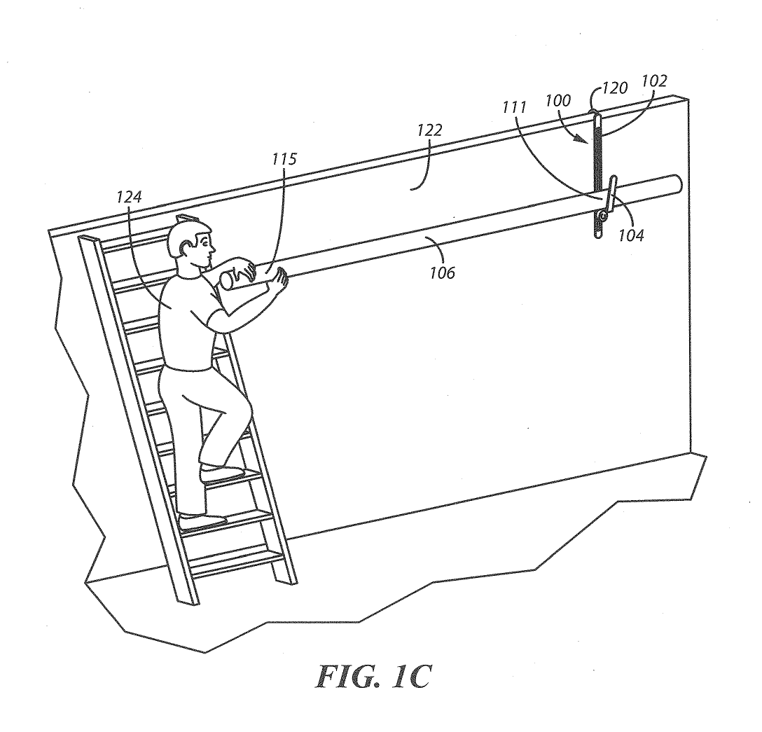

Referring now to FIG. 2A and FIG. 2B, another example of an apparatus 200 to support building support members during installation is described. The apparatus 200 includes a primary support rail 202 and a support member 204. The support member 204 is adjustably and movably coupled to the primary support rail 202 (via a slot 218 as described below). The support member 204 is configured to temporarily support an end portion of a building member and is coupled to the primary support rail 202 via an adjustment mechanism 208. The other end of the building member may be supported by a human user. Actuation of the adjustment mechanism 208 is effective to adjust a relative position of the support member 204 along the primary support rail 202. In other examples, the adjustment mechanism may be omitted and the member 204 is permanently attached to the rail 202.

The support member 204 can be configured to support a variety of different types, shapes, dimensions, and weights of building members. For example, the support member 204 may be a pipe-supporting bracket, a crown molding supporting bracket, a siding support bracket, or a board-supporting bracket. Other examples of support members are possible. The support member 204 may be constructed of any suitable material such as a metal, wood, or plastic. In this particular example, the support member is configured to hold a piece of crown molding.

In other aspects, the adjustment mechanism 208 is a turnable knob with a screw portion 216 that turns in the direction of the arrow labeled 210. Turning the mechanism 208 moves the screw portion 216 through the member 204, and then through the slot 218 in the rail 202 to provide a secure connection between the rail 202 and the support member 204. This action allows the support member 204 to move up and down the rail 202 in the direction indicated by the arrow labeled 212.

In some aspects, the primary support rail 202 includes a wall attachment member 220 and the wall attachment member 220 is configured to attach the primary support rail 202 to a wall or other building structure. In other aspects, the wall attachment member 220 is a nail-like element and can be pounded into a wall. The rail 202 may be constructed of any suitable material such as a metal, wood, or plastic.

In this example, the attachment member 220 is approximately 0.87 inches long; the rail 202 is approximately 10 inches long and approximately 0.12 inches thick. The adjustment member 208 is approximately 1.25 inches in diameter and has a knob approximately 0.50 inches thick. The support member 204 includes a first portion 232 (approximately 3.27 inches long), a second portion 234 (approximately 0.76 inches long) and a third portion 236 (approximately 2.00 inches long). The slot 218 is approximately 7.50 inches long and approximately 0.25 inches wide. Other examples of dimensions are possible.

Thus, an apparatus is provided that allows users to install building embers (e.g., crown moldings, boards, pieces of siding, or pipes) without the need for help from another human helper is provided. The apparatus is easy to assemble and allows the building member to be attached to a building structure (e.g., a wall, rafter, and ceiling, to mention a few examples) quickly and easily. Further, the apparatus is portable and can be move from job-to-job or location-to-location with ease.

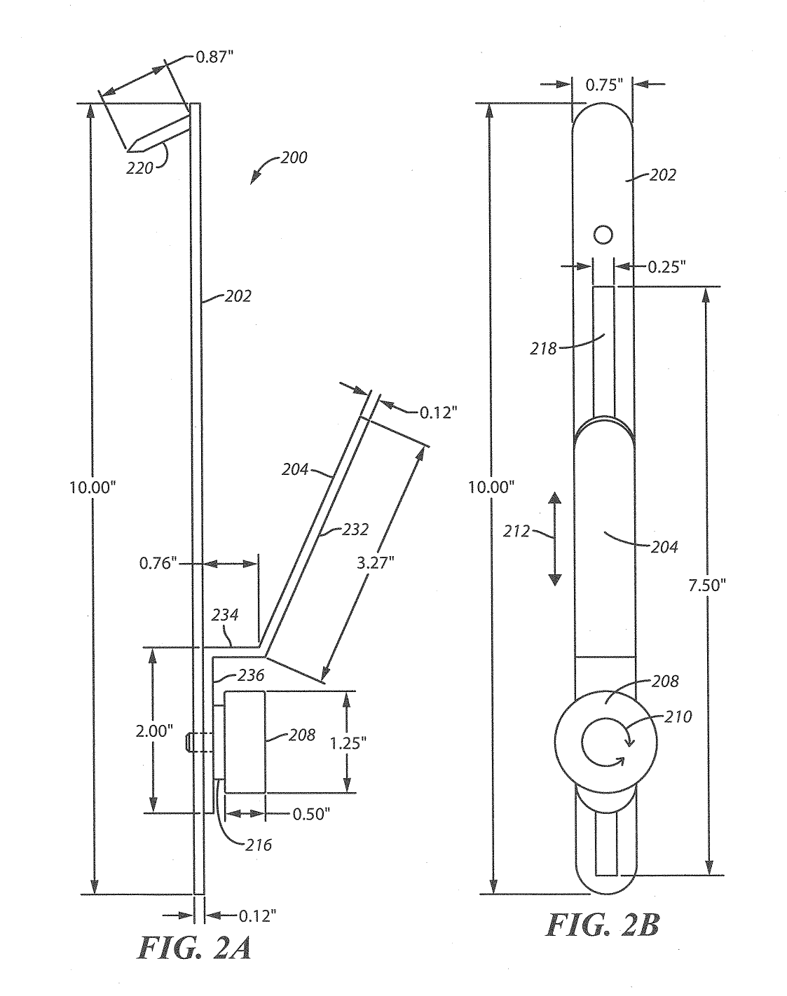

Referring now to FIG. 3A and FIG. 3B, another example an apparatus 300 to support building support members during installation is described. The apparatus 300 includes a primary support rail 302 and a support member 304. The support member 304 is adjustably and movably coupled to the primary support rail 302 (via a slot as described below). The support member 304 is configured to temporarily support an end portion of a building member and is coupled to the primary support rail 302 via an adjustment mechanism 308. The other end of the building member may be supported by a human user. Actuation of the adjustment mechanism 308 is effective to adjust a relative position of the support member 304 along the primary support rail 302.

The support member 304 can be configured to support a variety of different types, shapes, dimensions, and weights of building members. For example, the support member 304 may be a pipe-supporting bracket, a crown molding supporting bracket, a siding support bracket, or a board-supporting bracket. Other examples of support members are possible. The support member 304 may be constructed of any suitable material such as a metal, wood, or plastic. In this example, the support member 304 includes a first portion 332 (approximately 3.96 inches long), a second portion 334 (approximately 4.02 inches long), and a third portion 336 (approximately 4.00 inches long). Other dimensions are possible. The portions 334 and 336 are configured in a “V” type configuration and are configured to hold or support a pipe that can vary in size, for example, from approximately ½ inch to approximately 4½ inches in diameter.

In other aspects, the adjustment mechanism 308 is a turnable knob with a screw portion 316. Turning the mechanism 308 moves the screw portion 316 through the member 304, and then through the slot (not shown in FIG. 3A or 3B) in the rail 302 to provide a secure connection between the rail 302 and the support member 304. This action allows the support member 304 to move up and down the rail 302 in the direction indicated by the arrow labeled 312. In other aspects, the adjustment member 308 may be omitted.

In some other aspects, the primary support rail 302 includes a wall attachment member 320 and the wall attachment member 320 is configured to attach the primary support rail 302 to a wall or other building structure. In other aspects, the wall attachment member 320 is a nail-like element and can be pounded into a wall. The rail 302 may be constructed of any suitable material such as a metal, wood or plastic.

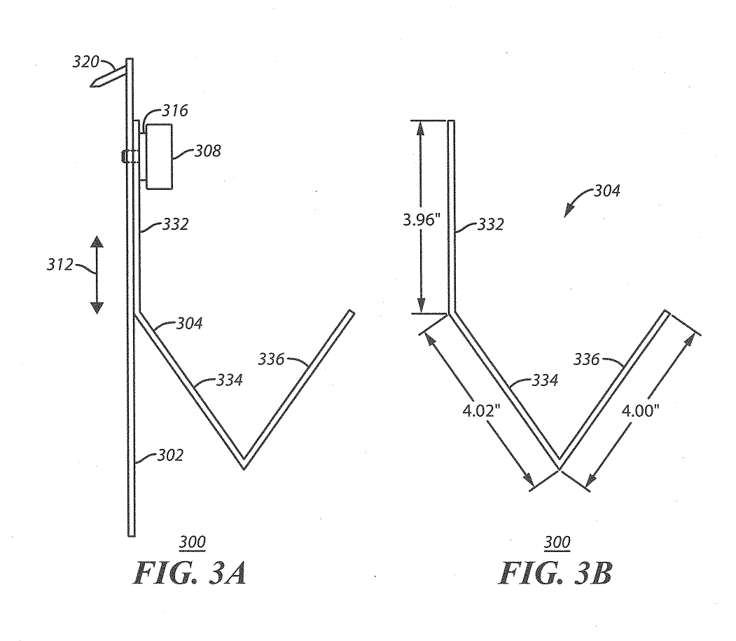

Referring now to FIG. 4A, a bracket 400 used to support small pipes is described. The bracket 400 includes a first vertical member 402 (approximately 1.50 inches long), a second vertical member 404 (approximately 2.00 inches long), and a horizontal member 406 (approximately 1.25 inches long), that are used to secure a pipe 408. The bracket 400 is attached to a primary support rail as described elsewhere herein.

Referring now to FIG. 4B a siding bracket 420 is described. The bracket 420 includes a first vertical member 422 (approximately 4.00 inches long), a second vertical member 424 (approximately 3.90 inches long), and a horizontal member 426 (approximately 0.63 inches long), that are used to secure siding 428. The bracket 420 is attached to a primary support rail as described elsewhere herein.

Referring now to FIG. 4C a bracket 440 used to support ledgers is described. The bracket 440 includes a first vertical member 442 (approximately 8.00 inches long), a second vertical member 444 (approximately 2.00 inches long), and a horizontal member 446 (approximately 2.00 inches long), that are used to secure a ledger 448. The bracket 440 is attached to a primary support rail as described elsewhere herein.

Referring now to FIG. 4D a bracket 460 to support large pipes is described. The bracket 460 includes a first vertical member 462 (approximately 2.75 inches long), a second vertical member 464 (approximately 2.00 inches long), and a horizontal member 466 (approximately 2.75 inches long), that are used to secure a pipe 468. The bracket 460 is attached to a primary support rail as described elsewhere herein.

Referring now to FIG. 4E a bracket to support crown molding is described. The bracket 480 includes a first vertical member 482 (approximately 3.27 inches long), a second vertical member 484 (approximately 2.00 inches long), and a horizontal member 486 (approximately 0.76 inches long), that are used to secure a pipe 488. The bracket 480 is attached to a primary support rail as described elsewhere herein.

It will be appreciated that the brackets 400, 420, 440, 460, and/or 480 may be included in a kit along with a primary support rail and an adjustment mechanism as has been described elsewhere herein. It will also be understood that the shapes and dimensions for the brackets of FIG. 4A-E are examples only and that other examples are possible.

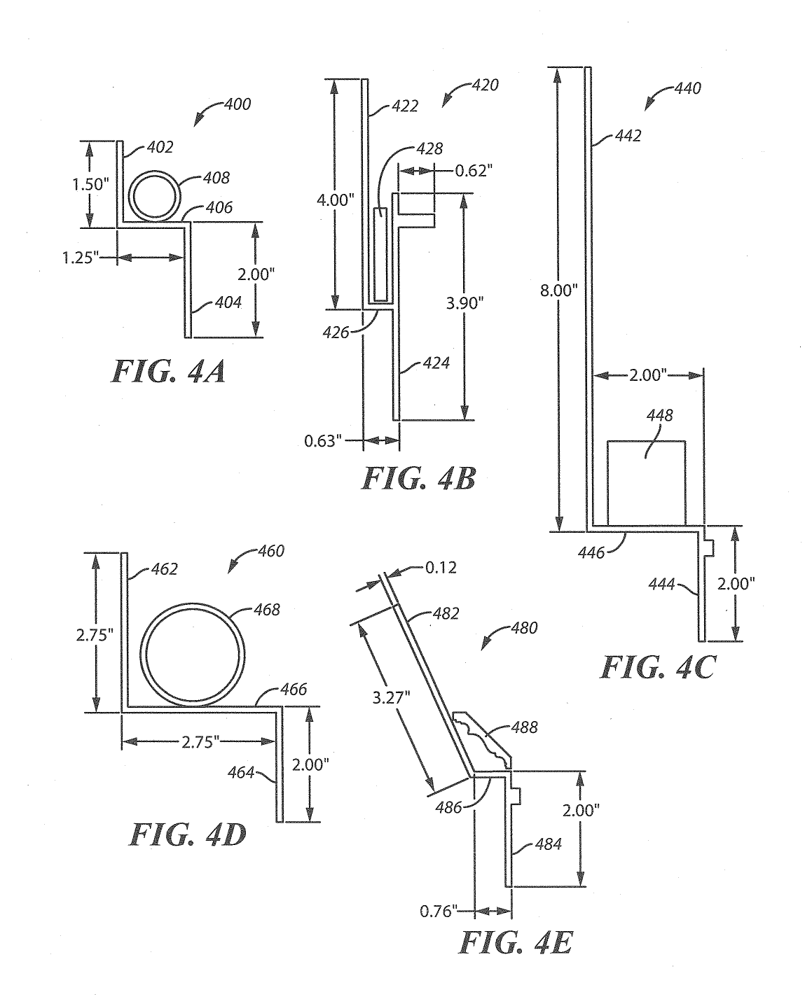

Referring now to FIGS. 5A and 5B a rail 502 is described. The rail 502 includes a slot 518 that extends therethrough. In this example, the rail 502 is approximately 14 inches long and the open slot 518 is approximately 11.52 inches long. This type of configuration may be advantageously used for heavier and/or longer building members (e.g., heavy pieces of siding). Other dimensions are possible.

Referring now to FIGS. 5C and 5D a rail is described. The rail 552 includes a slot 518 that extends therethrough. In this example, the rail 552 is approximately 10 inches long and the open slot 518 is approximately 7.5 inches long. This type of configuration may be advantageously used for lighter and/or shorter building members (e.g., small pipes). Other dimensions are possible.

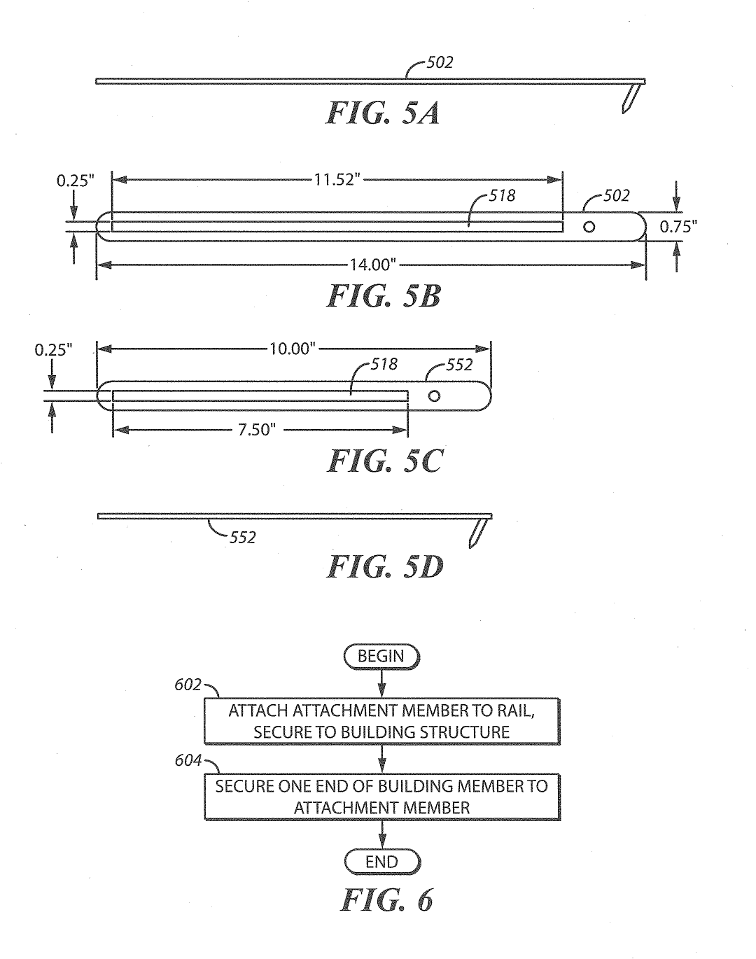

Referring now to FIG. 6 a flowchart of an approach for installing a building element is described. At step 602, a single user attaches a primary support rail to a building support structure. The primary support rail is coupled to a support member (e.g., any of the brackets described herein) and the support member is configured to temporarily support an end portion of a building member. Alternatively, the rail may be coupled to the building and then the support member coupled to the rail.

At step 604, one end of the building member is secured with or using the support member. The other end may be secured by the single user. The building member is secured to the building support structure by the single user without help from another human helper.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A portable apparatus for temporarily supporting one end portion of a building element, the apparatus comprising:
a primary support rail;
a support member that adjustably and movably couples to the primary support rail, the support member being configured to temporarily support an end portion of a building member, the support member being coupled to the primary support rail via an adjustment mechanism;
wherein actuation of the adjustment mechanism is effective to adjust a relative position of the support member along the primary support rail.

2. The apparatus of claim 1 wherein the support member comprises a member selected from the group consisting of: a pipe-supporting bracket, a crown molding supporting bracket, a siding support bracket, and a board-supporting bracket.

3. The apparatus of claim 1 wherein the adjustment mechanism comprises a turnable knob.

4. The apparatus of claim 1 wherein the primary support rail comprises a slot and the support member is configured to be coupled to the rail via a fastener that extends into the slot.

5. The apparatus of claim 1 wherein the primary support rail includes a wall attachment member, the wall attachment member configured to attach the primary support rail to a wall.

6. The apparatus of claim 5 wherein the wall attachment member comprises a nail or a screw.

7. The apparatus of claim 1 wherein the building member is selected from the group consisting of: a pipe, a crown molding, a section of siding, and aboard.

8. A kit that includes a portable apparatus for temporarily supporting one end portion of a building element, the kit comprising:
a primary support rail;
a plurality of support members that adjustably and movably couple to the primary support rail, each of the plurality of support members being configured to temporarily support an end portion of a different building member, the support members being coupled to the primary support rail via an adjustment mechanism;
wherein actuation of the adjustment mechanism is effective to adjust a relative position of the each of the support members along the primary support rail when each of the support members is coupled to the primary rail.

9. The kit of claim 8 wherein the plurality of support members are members selected from the group consisting of: a pipe-supporting bracket, a crown molding supporting bracket, a siding support bracket, and a board-supporting bracket.

10. The kit of claim 8 wherein the adjustment mechanism comprises a turnable knob.

11. The kit of claim 8 wherein the primary support rail comprises a slot and the support members are configured to be coupled to the rail via a fastener that extends into the slot.

12. The kit of claim 8 wherein the primary support rail includes a wall attachment member, the wall attachment member configured to attach the primary support rail to a wall.

13. The kit of claim 12 wherein the wall attachment member comprises a nail or a screw.

14. The kit of claim 8 wherein the building member is selected from the group consisting of: a pipe, a crown molding, a section of siding, and a board.

15. A method for a single user to attach a building element to a building support structure without the need of a human helper, the method comprising:
attaching a primary support rail to a building support structure, the primary support rail coupling to a support member, the support member being configured to temporarily support an end portion of a building member;
securing one end of the building member with the support member;
attaching the building member to the building support structure without help from another human helper.

16. The method of claim 15 wherein the building support structure comprises a wall.

17. The method of claim 15 wherein the building member is selected from the group consisting of: a pipe, a crown molding, a section of siding, and a board.

18. The method of claim 15 wherein the primary support rail includes a wall attachment member, the wall attachment member configured to attach the primary support rail to a wall.

19. The method of claim 18 wherein the wall attachment member comprises a nail or a screw.
